(19) United States
(12) Patent Application Publication
(10) Pub. No.: US 2004/0095321 A1
(43) Pub. Date: May 20, 2004

(54) Optical mouse

(76) Inventors: Tsung-Ting Sun, Taipei (TW); Jui-Chien Chuang, I Lan Hsien (TW); Cheng-Hung Tsai, Hsin Chu City (TW); Hsuan Kai Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/294,642

(22) Filed: Nov. 15, 2002

(51) Int. Cl. G09G 5/08

(52) U.S. Cl. 345/163

(57) ABSTRACT

An optical mouse includes at least one light emitter for emitting a light beam; a light receiver contained by a casing; a focusing lens arranged on the casing and placed between the light receiver and the work surface; wherein the light beam has only one reflection by the work surface during an optical path thereof and then propagates to the light receiver through the lens. The focusing lens can be replaced by a transparent dustproof lid, while the optical mouse still has acceptable efficiency.

### FIELD OF THE INVENTION

The present invention relates to an optical mouse, especially to an optical mouse with higher light transmission efficiency and lower cost.

### BACKGROUND OF THE INVENTION

In personal computer, the computer mice are popular pointing means for input data and cursor control. A conventional mechanical mouse generally employs a rolling ball and at least two encoder wheels for x- and y-axis. The encoder wheels are driven by the roll ball when a user moves the mouse along a flat surface such as a mouse pad. The encoder wheels will intermittently block a light propagation in the mouse and associated electronic signal is generated to control cursor movement on a computer display. However, the performance of the mechanical mouse is degraded after a long time use due to ball abrasion and dust inleakage. Moreover, the mechanical mouse uses a bulky and heavy steel ball, which is also inconvenient for user.

To overcome those drawbacks, an optical mouse is provided and has a light transmitter such as light emitting diode (LED), light receiver such as a photo diode and associated components. The prior art optical mouse should be operated on a patterned surface for modulating a light emitted from the light transmitter. The modulated light is received by the light receiver to identify mouse movement and control cursor motion.

However, the above-mentioned optical mouse required specialized mouse pad for normal operation, the applicability thereof is limited. As the advancement of complementary metal oxide semiconductor (CMOS) image sensor technologies and digital signal processing, the optical mouse can use CMOS sensor array to overcome above problem. The optical mouse may be operated at an non-transparent flat surface and the detected signals of the CMOS sensor array are analyzed to identify mouse movement and control cursor motion.

FIG. 1 shows a section view of partial components in a conventional optical mouse. The conventional optical mouse comprises a light transmitter 10 such as LED for emitting a light beam, a light emitting prism 12 and a light receiver 20 such as CMOS sensor array 20. As shown in this figure, the light emitting prism 12 has a special shape rendering the light beam impinging a work surface 100 with small incident angle. Therefore, a relatively large portion of reflected light from the work surface 100 can be detected by the light receiver 20. Even though the light beam is scattered by an uneven work surface 100, a larger portion of scattered light can be detected by the light receiver 20. The electrical signal associated with the received light is analyzed by a DSP element (not shown) in the mouse to identify mouse movement.

However, in the optical mouse shown in FIG. 2, the light emitting prism 12 with special shape is required such that the light beam has small incident angle as impinging the work surface 100 after experiencing two reflections by light emitting prism 12. The light emitting prism 12 requires considerable effort and cost to manufacture and assemble. Moreover, the multiple reflection by the light emitting prism 12 also cause an attenuation in intensity of light beam.

### SUMMARY OF THE INVENTION

It is the object of the present invention to provide an optical mouse with higher light transmission efficiency and lower cost.

In one aspect of the invention, the optical mouse of the present invention has at least one light emitter for emitting a light beam; a light receiver contained by a casing; a focusing lens arranged on the casing and placed between the light receiver and the work surface; wherein the light beam has only one reflection by the work surface during an optical path thereof and then propagates to the light receiver through the lens.

In another aspect of the invention, the focusing lens can be replaced by a transparent dustproof lid, while the optical mouse still has acceptable efficiency.

The various objects and advantages of the present invention will be more readily understood from the following detailed description when read in conjunction with the appended drawing, in which:

### BRIEF DESCRIPTION OF DRAWING

FIG. 1 shows a section view of partial components in a conventional optical mouse;

FIG. 2 shows a sectional view of an optical mouse according to the first preferred embodiment of the present invention;

FIG. 3 show a sectional view of an optical mouse according to the second preferred embodiment of the present invention; and

FIG. 4 show a sectional view of an optical mouse according to the third preferred embodiment of the present invention.

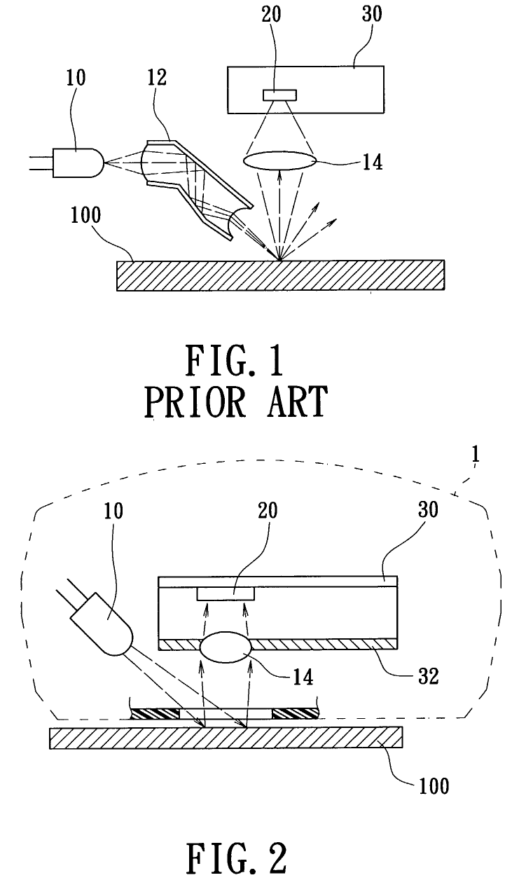

### DETAILED DESCRIPTION OF THE INVENTION

FIG. 2 shows a sectional view of an optical mouse 1 according to the first preferred embodiment of the present invention. The optical mouse 1 according to this preferred embodiment of the present invention comprises at least a light transmitter 10 such as LED for emitting a light beam, a casing 30, a light receiver 20 (such as CMOS sensor array or CCD array) 20 arranged on the casing 30, and a focusing lens 14. The light beam emitted from the light transmitter 10 is reflected once by a work surface 100 and then propagates to the light receiver 20 through the converging action of the focusing lens 14. In this preferred embodiment, the light emitting prism 12 with a special shape is eliminated to reduce cost and assembling effort. Moreover, the light beam is subjected to only one reflection by the work surface 100, the transmission efficiency is enhanced. Therefore, a low-power light source is feasible and the cost can be further reduced.

In above-mentioned preferred embodiment, the focusing lens 14 can be separately formed and then assembled to the casing 30. Moreover, the focusing lens 14 can be one of a ball lens, a graded-index (GRIN) lens, a Fresnel lens, a concavoconvex lens, or a planoconvex lens). Alternatively, the lens 14 can be integrally formed with the casing 30. In this case, a portion of the casing 30 is subjected to a matted treatment to form a matted face 32 to prevent interference from multiple refection inside the casing 30. The lens 14 can be placed with various distance to the light receiver 20 such that the image-object ratio is adjusted to 1:1, 1:N or N:1, wherein N is positive integer number.

In this preferred embodiment, the lens 14 can be provided with interference pattern to generate interference signal such as shadow Moiré to the light receiver 20. Moreover, a hologram can be incorporated into the optical path of the mouse to manipulate a light beam from the coherent light source, i.e., the light transmitter 10. The manipulated light beam received by the light receiver 20 can also be used to identify mouse movement. Moreover, the inventor had found that the optical power is still sufficient if the lens 14 is removed from the optical path in the arrangement of the optical mouse according to the present invention. This can be attributed to the efficiency enhancement provided by the mouse structure of the present invention wherein only one reflection is occurred. In this case, a transparent dustproof lid (not shown) is provided to prevent the inleakage of dust.

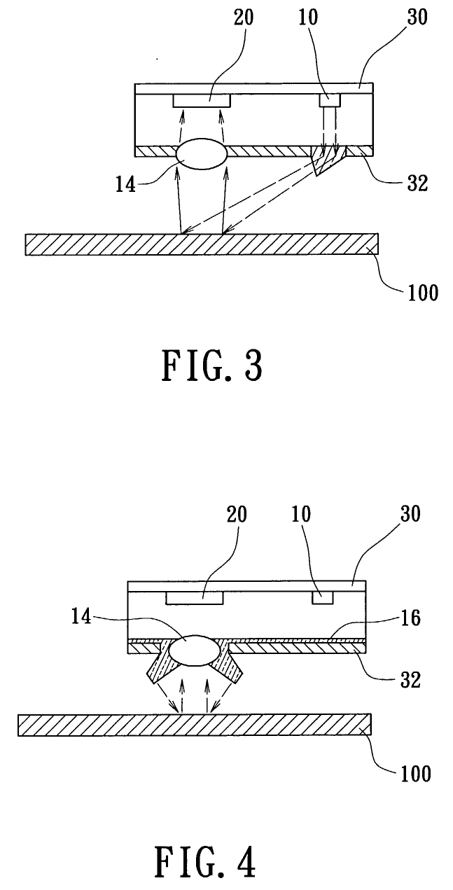

FIG. 3 show a sectional view of an optical mouse 1 according to the second preferred embodiment of the present invention. In this preferred embodiment, the light transmitter 10 is placed within the casing 30 to reduce size of the optical mouse and assembling cost. It should be noted a light guiding section (not labeled, the wedge shape shown in the figure) is provided to guide the light beam out of the casing 30.

FIG. 4 show a sectional view of an optical mouse 1 according to the third preferred embodiment of the present invention. In this preferred embodiment, the light transmitter 10 is placed within the casing 30 and at least one light guide 16 is provided to guide the light beam toward the work surface 100. The light beam is subjected to one reflection and then received by the light receiver 20. Moreover, in the case that the light transmitter 10 is placed outside the casing 30, at least one light guide 16 is provided to guide the light beam toward the work surface 100.

It should be noted the optical mouse according to the present invention has various modifications. For examples, the LED can be lamp type LED, surface mount device (SMD) LED, lateral side emission LED or oblique emission LED. The LED can emit light covering wavelength region of single color, dual color or multiple color. The LED can be packaged by plastic leadless chip carrier (PLCC), glob-top COB (chip on board) or transfer molding COB. The work surface also includes a finger print.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. An optical mouse operated on a work surface, comprising
at least one light emitter for emitting a light beam;
a light receiver contained by a casing;
a focusing lens arranged on the casing and placed between the light receiver and the work surface; wherein
the light beam has only one reflection by the work surface during an optical path thereof and then propagates to the light receiver through the lens.

2. The optical mouse as in claim 1, wherein the focusing lens is assembled to the casing.

3. The optical mouse as in claim 2, wherein the focusing lens is one of a ball lens, a graded-index (GRIN) lens, a Fresnel lens, a concavoconvex lens, and a planoconvex lens.

4. The optical mouse as in claim 1, wherein the focusing lens is integrally formed with the casing.

5. The optical mouse as in claim 4, wherein the focusing lens is one of a ball lens, a graded-index (GRIN) lens, a Fresnel lens, a concavoconvex lens, and a planoconvex lens.

6. The optical mouse as in claim 4, wherein a partial outer surface of the casing is subjected to matted treatment.

7. The optical mouse as in claim 1, wherein the focusing lens has interference pattern.

8. The optical mouse as in claim 1, wherein the work surface also includes a finger print.

9. The optical mouse as in claim 1, further comprising a hologram in the optical path.

10. The optical mouse as in claim 1, wherein the lens is placed at a predetermined position such that an image of the work surface has image-object ratio of one of 1:1, 1:N and N:1, wherein N is positive integer number.

11. The optical mouse as in claim 1, wherein the light emitter is placed in the casing.

12. The optical mouse as in claim 10, further comprising a light guide to guide the light beam of the light emitter out of the casing and toward the work surface.

13. The optical mouse as in claim 1, wherein the light emitter is light emitting diode.

14. The optical mouse as in claim 13, wherein the light emitting diode is one of lamp type LED, surface mount device (SMD) LED, lateral side emission LED or oblique emission LED.

15. The optical mouse as in claim 13, wherein the light emitting diode emits a light of single wavelength.

16. The optical mouse as in claim 13, wherein the light emitting diode emits a light of multiple wavelengths.

17. The optical mouse as in claim 13, wherein the light emitting diode is packaged by one of plastic leadless chip carrier (PLCC), glob-top COB (chip on board) or transfer molding COB.

18. An optical mouse operated on a work surface, comprising
at least one light emitter for emitting a light beam;
a light receiver contained by a casing; wherein
the light beam has only one reflection by the work surface during an optical path thereof and then propagates to the light receiver through the lens.

19. The optical mouse as in claim 18, further comprising a transparent dustproof lid.
